(19) United States
(12) Patent Application Publication
(10) Pub. No.: US 2013/0292438 A1
(43) Pub. Date: Nov. 7, 2013

(54) ADJUSTABLE PANNIER FRAME

(71) Applicants: Timothy Kent Armstrong, Christchurch (NZ); Gary Alan Gibson, Christchurch (NZ); Patrick David Maguire, Christchurch (NZ)

(72) Inventors: Timothy Kent Armstrong, Christchurch (NZ); Gary Alan Gibson, Christchurch (NZ); Patrick David Maguire, Christchurch (NZ)

(21) Appl. No.: 13/816,544

(22) PCT Filed: Aug. 29, 2011
(86) PCT No.: PCT/NZ11/00173

§ 371 Date: May 1, 2013

(30) Foreign Application Priority Data
Aug. 27, 2010 (NZ) 587637

(51) Int. Cl. B62J 9/00

(52) U.S. Cl. CPC B62J 9/00
USPC 224/447

(57) ABSTRACT

A pannier frame assembly, which includes at least one pannier frame member and at least one connector element on each side of a bicycle rack having a top deck, the at least one connector element configured to releasably hold the pannier frame member, the at least one connector element and/or pannier frame member is configured to allow the pannier frame member to be adjusted in a forward and/or backward direction with respect to the bicycle rack, in use, when mounted to a bike.

### STATEMENT OF CORRESPONDING APPLICATIONS

This application is based on the provisional specification filed in relation to New Zealand Patent Application Number 587637, the entire contents of which are incorporated herein by reference.

### TECHNICAL FIELD

The present invention relates to an adjustable pannier frame.

### BACKGROUND ART

There are a relatively small number of systems by which pannier bags are or can be attached to a bicycle. These systems fall into two categories:
those that comprise a dedicated system, requiring the fitment of a proprietary pannier rack to the bicycle, onto which the pannier bag attaches; or
those that attach to a standard bicycle rack.

The present invention is only concerned with those pannier bags that fall into the second category and attach to a standard bicycle rack.

It will be known to a person skilled in the art that a standard bicycle rack includes:
at least one substantially horizontal upper frame member;
at least one lower frame member,

wherein, in use, the attachment system of the pannier bags attaches to the horizontal upper frame member such that the weight of the pannier and its contents are supported thereby; and

wherein the lower frame member provides an abutment onto which the back of the pannier rests, preventing the rotation of the pannier about the upper frame member and into the bicycles wheel.

It will also be apparent to a person skilled in the art that a large number of bicycle racks also exist which do not provide one or more of the features required for attachment of a pannier bag, namely:
at least one substantially horizontal upper frame member;
at least one lower frame member.

It would therefore be useful to have a system which can be retrofitted to non-pannier compatible bicycle racks so as to enable pannier bags to now be supported by the modified (retrofitted) bicycle rack.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention there is provided a pannier frame assembly which includes:
at least one pannier frame member; and
at least one connector element on each side of a bicycle rack having a top deck, the at least one connector element configured to releasably hold the pannier frame member,

characterised in that the at least one connector element and/or pannier frame member is/are configured to allow the pannier frame member to be adjusted in a forward and/or backward direction with respect to the bicycle rack, in use, when mounted to a bike.

For the purposes of clarity, a bicycle rack should be understood to include at least the following features:
a top deck; this is the uppermost substantially flat load bearing surface provided by a bicycle rack;
an attachment member; typically bicycle racks attach to one or more of:
   seat stays;
   seat post;
   rack mounts on the rear dropouts;
   fork crown;
   fork legs;
   fork leg rack mounts.

In some embodiments the connector element may be in the form of a length of material which has both ends thereof adapted to hold the top frame member the length of material being connected to the top deck or support member of a bicycle rack. The length of material may be clipped, or otherwise connected to the top deck or support member of the bicycle rack.

In other preferred embodiments the at least one connector element may be in the form of clamp members on the sides of the bicycle rack top deck.

In preferred embodiments the clamp members may be formed integrally with the top deck.

In other embodiments the clamp members may be attached to the top deck by way of screws, hooks, clamps or the like.

In preferred embodiments one or more clamp members may be attached to the sides of the top deck.

In especially preferred embodiments at least four clamp members are attached to the top deck of the bicycle rack, two per side and located in substantially fore and aft positions on the top deck.

In preferred embodiments the clamp members comprise a bottom fixed jaw and a releasable top jaw. Any weight applied to the clamps is being distributed to the top deck of the bicycle rack.

In other preferred embodiments the clamp members may comprise a deformable aperture through which a pannier frame member may be located. It will be apparent to a person skilled in the art that a screw or bolt or the like may be used to cause deformation of the aperture to thereby retain the pannier frame member in place.

In some preferred embodiments the connector element is in the form of two spaced apart straps.

In alternative preferred embodiments in which the connector elements are straps, the straps may be a fixed length and have loops at each end thereof and in use loop substantially over a bicycle rack top deck. Any weight applied to the straps may thereby be distributed to the top deck of the bicycle rack.

In some further preferred embodiments in which the connector elements are straps, the straps may be adjustable in length. Adjustability of the length of the straps allows for a corresponding adjustability in the height of an attached pannier frame, and pannier bag. This provides user configurability in terms of either increased ground clearance or a lower centre of mass and therefore greater stability. Adjustable length straps are known in the art and typically include hook and loop fasteners, strap buckles, loop fasteners or the like. As such the manner is which the straps may be lengthened or shortened should not be seen as limiting.

It will be apparent to a person skilled in the art that the advantage of supporting the pannier frame by way of a flexible or resilient connector element is that some degree of suspension action is conferred to any attached pannier bag, thereby reducing the stress applied to an associated bicycle rack and bicycle.

In embodiments which utilise connector elements in the form of straps, the pannier frame assembly may include at least one spreader element.

In preferred embodiments the at least one spreader element is wider than the top deck of the bicycle rack and, in use, may hold the flexible connector elements away from the bicycle rack.

In especially preferred embodiments the connector elements are spaced apart on either side of the top deck to provide substantially vertical alignment of the pannier frame(s) when they are installed on a bicycle rack.

In preferred embodiments the spreader elements include apertures at each end thereof through which the straps, or part thereof, can pass through.

In some preferred embodiments the spreader elements may be formed integrally with the straps. Integrated spreader elements could take a number of forms, such as, for example, dual compound plastics which feature a rigid central plastic spreader from which depends flexible plastic straps. Further examples of integrated spreader/strap elements could be in the form of fabric straps which are bonded or fused to a plastic spreader element. Therefore the exact manner is which the spreader element and straps are integrally formed should not be seen as being limiting.

In some embodiments the spreader elements may be formed integrally with the top deck.

In other embodiments the spreader elements may be separate from the straps, but may retain the straps thereon. It will be apparent to a person skilled in the art that a strap or the like can be retained in position by a suitably configured tortuous path through or about the spreader element. Retainment by means of a tortuous path is well known in the art and should therefore not be seen as limiting. The straps could equally be retained by a clamp without departing from the scope of the present invention.

According to a further aspect of the present invention there is provided a pannier frame which includes:
an upper frame member;
a lower frame member; and
a guard member,

wherein the lower rail includes at least one lower frame member connection device; and

wherein the upper frame member is configured to be capable in use engaging with at least one connector element of a bicycle rack in a manner which allows the pannier frame to be adjusted in a forward or backward direction with respect to the rack.

In one preferred embodiment the upper frame member may comprise a tube which slidably engages with the at least one connector element of a bicycle rack.

In a further embodiment the upper frame member may include a plurality of attachment portions which are configured to engage with the at least one connector element of a bicycle rack. Examples of such attachment portions may include, but should not be limited to, loops or apertures in an upper frame member which are configured to fit over at least a portion of a corresponding connector element on a bicycle rack.

In preferred embodiments the upper frame member is configured to facilitate attachment of a standard hook type pannier bag attachment system.

It will be apparent to a person skilled in the art that the pannier frame(s) may be constructed from any number of materials. A non limiting list of possible materials being:
an metal extrusion;
carbon fibre; and
plastic.

In preferred embodiments the pannier frame is constructed from a single length of material that can be bent and formed into regions corresponding to each of an upper frame member, a lower frame member, and a guard.

In other embodiments the upper frame member, lower frame member, and guard may be formed from a suitably configured mould which has regions corresponding to an upper frame member, a lower frame member, and a guard.

In preferred embodiments the upper frame member is substantially equivalent in length to the length of a standard bicycle rack upper deck.

In especially preferred embodiments the upper frame member is configured so as to receive the attachment mechanism of a pannier bag of the type that would typically be attached to a standard bicycle rack having an upper frame member and a lower frame member, or the equivalent thereof

In preferred embodiments the lower frame member runs substantially parallel to, but may be shorter in length than the upper frame member. Preferably, the lower frame member may be substantially centrally disposed below the said upper frame member. The lower frame member provides a support against which the back of an attached pannier bag can rest. It will be apparent to a person skilled in the art that a high attachment point on the back of a pannier bag will result in the pannier bag wanting to rotate about the top frame member and into the wheel of the bicycle. The lower frame member may limit or prevent this rotation.

The guard member provides further support to the pannier bag, preventing the bottom of the bag from moving into the bicycle wheel. This is especially useful for pannier bags which do not include a rigid backing material.

In preferred embodiments in which the connector elements of the bicycle rack are straps, the top frame member of the pannier frame attaches to the straps.

In especially preferred embodiments the attachment is by way of passing the top frame member through loops formed in the ends of the straps.

In preferred embodiments in which the connector elements of the bicycle rack are clamps comprising a fixed lower jaw and releasable upper jaw, wherein the top frame member of the pannier frame passes between the fixed lower jaw and releasable upper jaw of the clamp. Clamping of the releasable jaws of the clamps resulting in the top frame member of the pannier frame being held rigidly in position.

In preferred embodiments in which the connector elements of the bicycle rack are clamps comprising a deformable aperture, the top frame member of the pannier frame passes through the deformable aperture. Deformation of the aperture through tightening of a screw or the like resulting in the top frame member of the pannier frame being held rigidly in position.

In preferred embodiments the lower frame member connection device is a dual clamp arrangement, wherein the first clamp of the dual clamp arrangement clamps onto a bicycle rack or bicycle frame and the second clamp clamps onto the lower frame member or part thereof.

In preferred embodiments a first clamp of the dual clamp clamps onto a portion of a bicycle rack or bicycle frame and the second clamp of the dual clamp clamps onto the lower frame member.

In some preferred embodiments the lower frame member connection device is a c-clamp.

In preferred embodiments the c-clamp may be connected to the lower frame member by way of an adjustment slot.

In preferred embodiments the c-clamp may include:
a first clamp portion;
a second clamp portion; and
a fastening device,

wherein the fastening device may be connected to the second clamp portion in a manner which allows the first clamp portion to be clamped therebetween.

In preferred embodiments the first clamp portion may be a fixed clamp portion.

In preferred embodiments the second clamp portion may be a pivotable clamp portion. A pivotable clamp portion should be understood to be pivotable with respect to at least one non-pivotable, or fixed, clamp portion. However, further embodiments may include first and second clamp portions which are pivotable with respect to each other, therefore the configuration of the clamp members should not be seen as being limiting.

In preferred embodiments the fastening device may be a quick release cam. Quick release cams are most commonly found on bicycle wheel and seatpost quick release assemblies.

In other preferred embodiments the fastening device may be a bolt, screw or similar tensioning device. It will be apparent that any number of known tensioning devices exist that would achieve the desired tensioning effect, therefore the exact embodiment used should not be seen as limiting.

In other embodiments the clamp may be a ratchet style clamp or similar. The exact nature of the clamp should therefore not be seen as limiting.

In preferred embodiments the pannier frame is configurable in at least a direction of forward or rearward adjustability with respect to the bicycle rack.

In other preferred embodiments the pannier frame is configurable in a further direction of upward or downward adjustability.

According to a further aspect of the present invention there is provided a kit of parts for the adaption of a non-pannier compatible bicycle rack to allow fitment of pannier bags thereto, the kit of parts including:
at least two connector elements in the form of straps;
(optionally) at least two spreader elements;
at least one pannier frame member; and
at least one lower frame connection device in the form of a clamp.

It will be understood by a person skilled in the art that the spreader elements are optional in the sense they are generally only required in preferred embodiments where the connector elements are in the form of straps.

In a further aspect of the present invention there is provided a method of adapting a non-pannier compatible bicycle rack having a top deck to allow fitment of pannier bags thereto, the method including the steps of:
a) setting the height of at least one pannier frame by increasing or decreasing the length of, or selecting an appropriate length of at least one connector element strap;
b) placing the at least one connector element strap through or over the bicycle rack top deck;
c) attaching the top frame member of the/or each pannier frame to the corresponding ends of the at least one connector element strap;
d) attaching a lower frame member connection device to a lower frame member of the pannier frame and to at least a portion of the bicycle rack;
e) positioning the or each pannier frame by sliding it forward or backward relative to the bicycle rack;
f) tensioning the pannier frame downwards by applying weight to the pannier frame and tightening the connection device to fix the position of the pannier frame.

In some embodiments the method of adapting a non-pannier compatible bicycle rack may include the further step of adding at least one spreader element below the top deck and attaching the at least one connector element strap thereto. The purpose of the spreader element is to add support to the connector element straps and to position the top of the pannier frame to be substantially vertical above the bottom of the pannier frame.

According to a further aspect of the present invention there is provided a system of supporting a pannier bag on a bicycle, wherein the bicycle includes a bicycle rack having an attached pannier frame assembly which includes:
at least two connector elements;
at least two pannier frame members which comprise a top frame member, lower frame member and a guard,

wherein the connector elements are configured to, in use, connect a pannier frame to each side of the bicycle rack and wherein the lower frame member includes a connection device adapted to, in use, connect the lower frame member to the bicycle rack or bicycle frame.

Thus, certain preferred embodiments of the present invention may have a number of advantages over the prior art which can include one or more of the following:
the pannier frame is attached to the bicycle rack in a suspended manner, thereby reducing impact related stress on the bicycle rack and bicycle;
three point fixing is provided for each pannier frame, providing a strong and reliable connection;
the position of the pannier frame is user adjustable and is held in any configurable position by tensioning the pannier frame and locking in place via the lower connection device;
the pannier frame is mounted is a manner that allows lateral forward and aft adjustment allowing the pannier to be positioned to avoid heel clash or allow clearance for bicycle suspension systems to operate;
the pannier frame is mounted is a manner that allows upward and downward movement, allowing the pannier to be positioned to provide greater ground clearance or a lower centre of gravity and therefore greater stability.

### BRIEF DESCRIPTION OF THE DRAWINGS

Further aspects of the present invention will become apparent from the following description which is given by way of example only and with reference to the accompanying drawings in which:

FIG. 1 shows a side profile view of a preferred embodiment of a pannier frame assembly according to the present invention attached to a non-standard bicycle rack;

FIG. 2 shows a bottom isometric view of the pannier frame assembly of FIG. 1 attached to a non-standard bicycle rack;

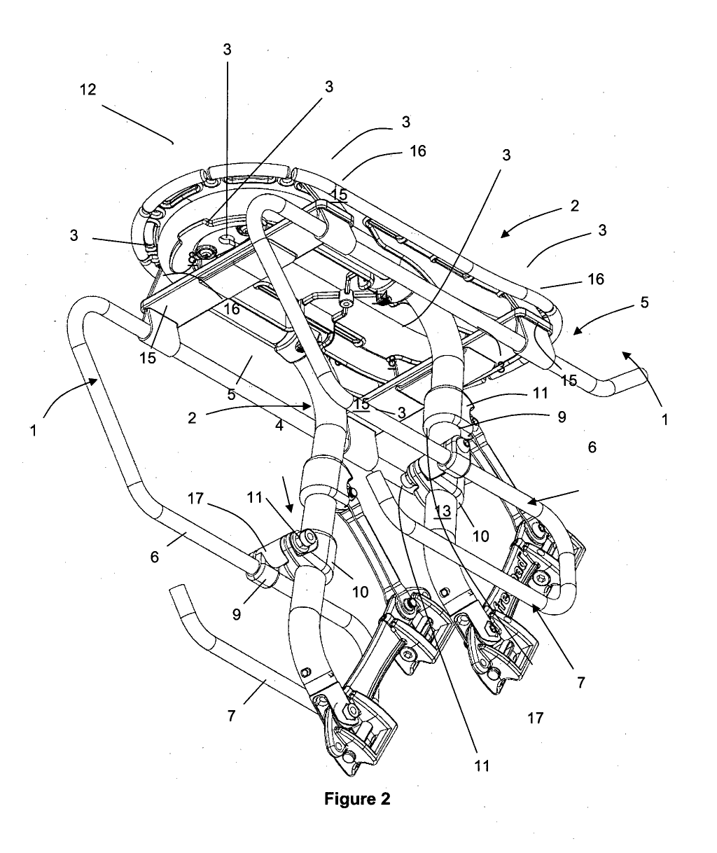

FIG. 3 shows a top isometric view of the pannier frame assembly of FIG. 1 attached to a non-standard bicycle rack;

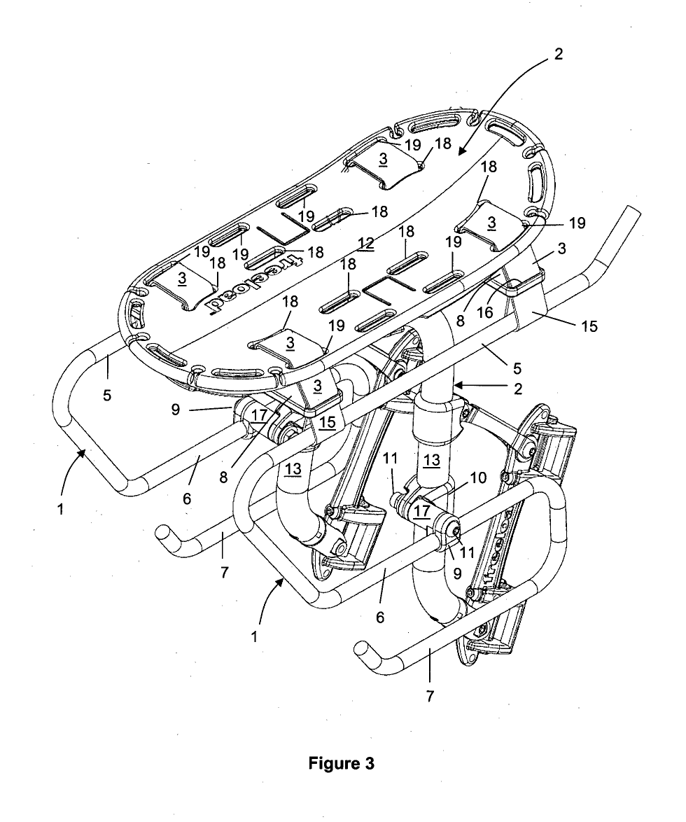

FIG. 4 shows a top isometric view of a further preferred embodiment of a pannier frame assembly according to the present invention, attached to a non-standard bicycle rack;

FIG. 5 shows a bottom front isometric view of the preferred embodiment of a pannier frame assembly shown in FIG. 4; and

FIG. 6 shows an isometric view of a pannier frame as shown in FIGS. 4 and 5.

### BEST MODES FOR CARRYING OUT THE INVENTION

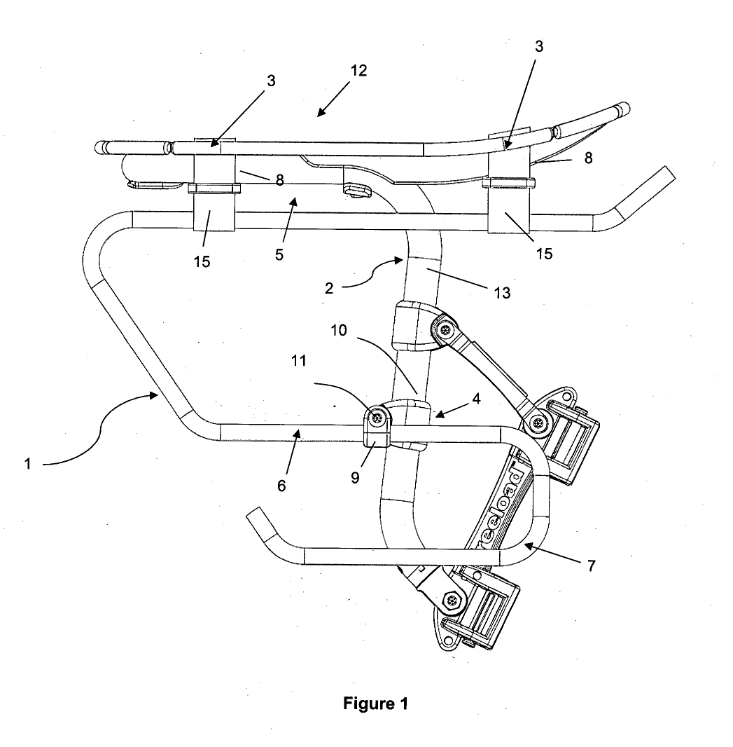

With respect to FIG. 1, there is shown a pannier frame, as generally indicated by arrow 1. The top frame member 5 of pannier frame 1 is attached to a freeload™ bicycle rack 2 and top deck 12 by flexible connector element in the form of webbing straps 3 and is connected to connection device 4. Top frame member 5 of bicycle rack 2 passes through the looped ends 15 of webbing straps 3. The pannier frame 1 is held in substantially vertical alignment by spreaders 8 which include slots 16 through which the looped ends 15 of webbing straps 3 are passed, thereby holding the webbing straps 3 away from the bicycle rack 2.

Connection device 4 includes:
first u-clamp 9 which is located around a lower frame member 6 of pannier frame 1; and
second u-clamp 10 which is located around lower support 13 of bicycle rack 2.

First u-clamp 9 includes spacer 17. Clamp bolt 11 passes through each of first u-clamp 9, spacer 17 and second u-clamp 10. Upon tightening clamp bolt 11 first clamp 9 is clamped to lower pannier frame 1 frame member 6, spacer 17 is clamped to second clamp 10 and second clamp 10 is clamped to bicycle rack lower support 13.

For ease of understanding, the operation of the pannier frame will now be explained in terms of installation of the pannier frame onto a freeload™ bicycle rack 2, the installation steps being:
1. positioning spreaders 8 beneath underside 14 of top deck 12 adjacent first apertures 18 in the deck 12;
2. optionally setting the pannier frame 1 vertical height by increasing or decreasing the length of free webbing material by releasing it or confining it to a tortuous path (not shown);
3. threading looped ends 15 of webbing straps 3 through top deck 12 first apertures 18;
4. threading looped ends 15 of webbing straps 3 through top deck 12 second apertures 19;
5. threading looped ends 15 of webbing straps 3 through spreader(s) 8 apertures 16;
6. threading top frame members 5 of pannier frames 1 through looped ends 15;
7. attaching connection device 4 first u-clamp 9 to lower frame member 6 and second u-clamp 10 to rack lower support 13 with spacer 17 located therebetween and installing clamp bolt 11 without tightening;
8. positioning the pannier frame 1 horizontally by sliding it forward or backward in the looped ends 15 of the webbing straps 3 and first u-clamp 9 so as to provide sufficient clearance between the heels of the bicycle operator (not shown) and where an attached pannier bag would sit (not shown);
9. tensioning the pannier frame 1 downwards by applying weight to the pannier frame 1 and tightening clamp bolt 11 to fix the position of the pannier frame.

In use, a pannier bag (not shown) is attached to the top frame member 5 of the pannier frame 1 by way of hooks or other proprietary attachment devices. Top frame member 5 being of a diameter and/or shape designed to correspond to a pannier bag compatible bicycle rack (not shown) top frame member (not shown). The weight of an attached pannier bag is mostly supported by top frame member 5 through webbing straps 3 and onto bicycle rack 2 top deck 12. A small proportion of the weight is supported through connection device 4. Therefore any shock loads, such as bumps in the path of the bicycle, will be absorbed in part by the webbing straps 3, and in part by the pannier frame 1 and connection device 4, thereby reducing the stress on the bicycle rack (2) and bicycle (not shown).

It will be understood by a person skilled in the art that a pannier bag (not shown) that does not include a rigid backing material would be capable of folding inwards at the bottom and potentially hitting the bicycle wheel. A guard member 7 provides further support to a pannier bag (not shown) attached to the pannier frame 1, thereby preventing the bottom of the pannier bag from folding inwards towards the wheel (not shown).

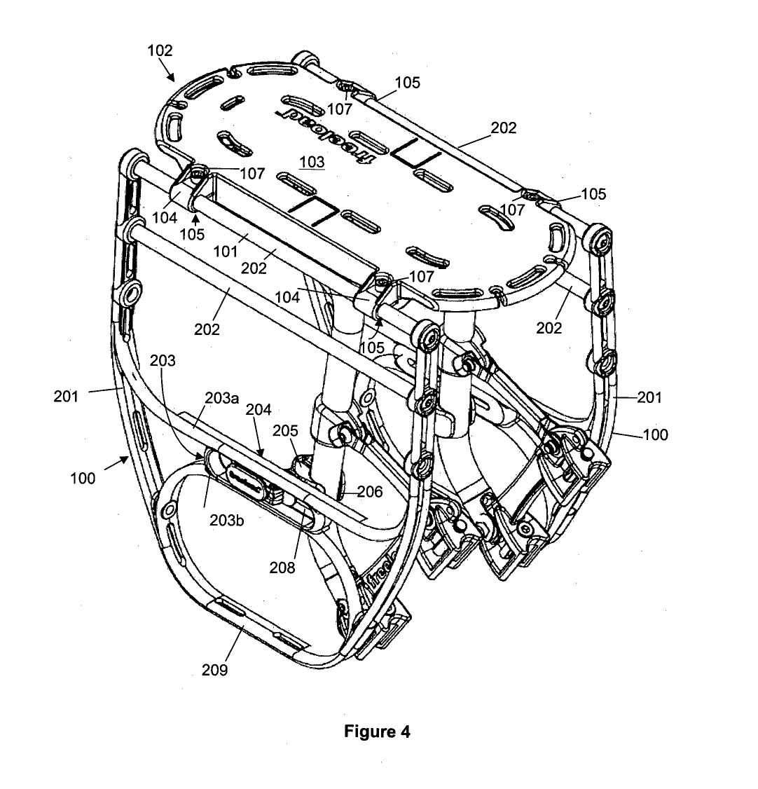

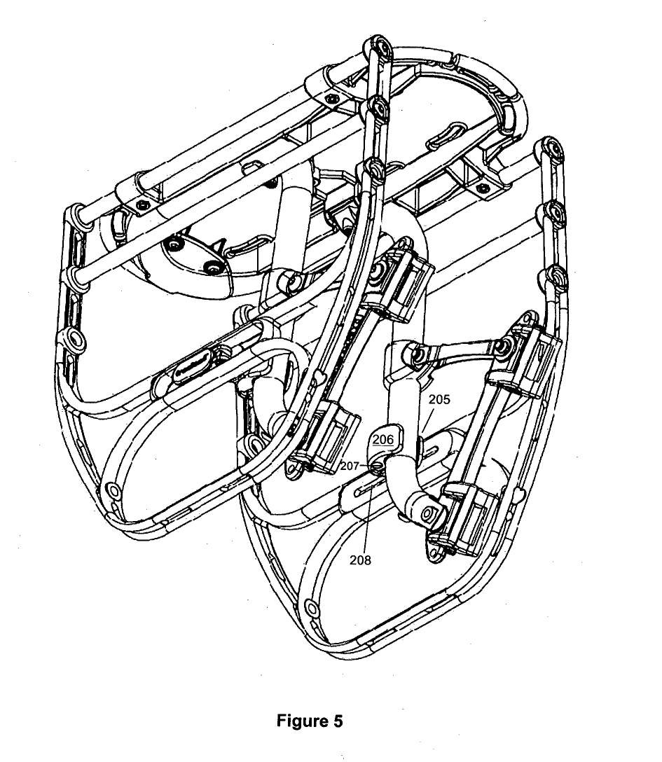

With respect to FIGS. 4 and 5 there is shown a pannier frame, as generally indicated by arrow 100. The upper frame member 101 of the pannier frame is shown attached to a freeload™ bicycle rack 102 top deck 103 by connector elements in the form of pinch clamps 104. The pinch clamps 104 are integrally formed into top deck 103. Upper frame member 101 passes through pinch clamp 104 aperture 105. Upper frame member 101 is secured in place by tightening pinch clamp bolt 107, thereby deforming aperture 105 such that it grippingly retains upper frame member 101 therein.

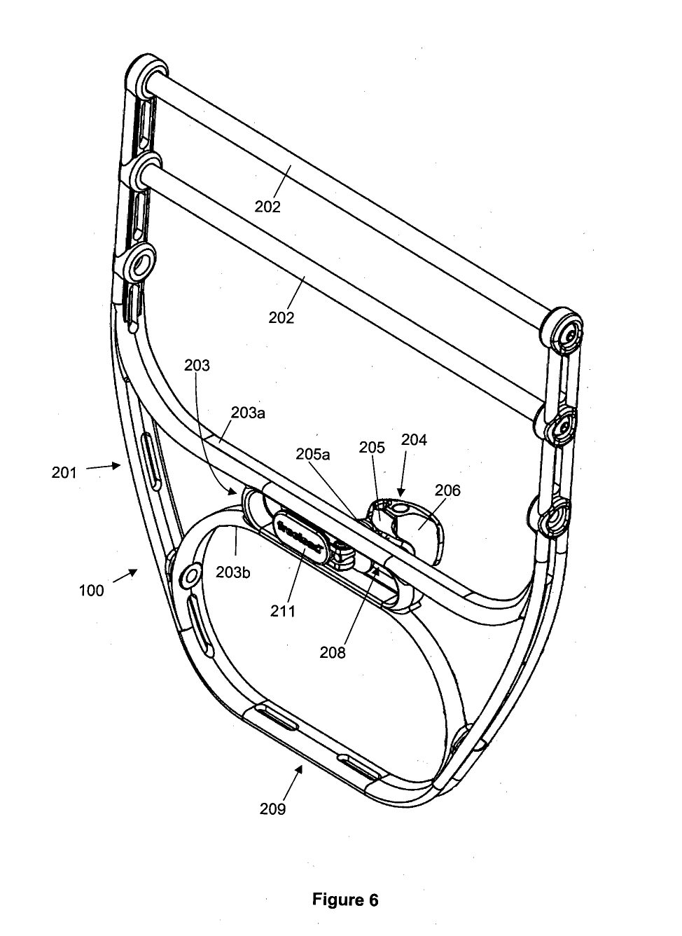

Pannier frame 100 as shown in FIGS. 4, 5 and 6 comprises composite body 201, to which three rails 202 are attached (only two of which are shown in FIGS. 4, 5 and 6). Pannier frame 100 also includes a lower frame member 203 formed into the composite body 201. In the embodiment of FIGS. 4, 5 and 6, the lower frame member 203 comprises first 203a and second 203b lower frame members. Attached to lower frame member 203, in adjustment slot 208 between first 203a and second 203b lower frame members is a lower frame member connection device in the form of c-clamp 204.

With respect to FIG. 5 there is shown c-clamp 204, which includes fixed clamp portion 205, and pivotable clamp portion 206. Fixed clamp portion 205 has a base 205a which abuts the rear of lower frame member 203 adjacent adjustment slot 208. c-clamp 204 can be configured for adjustment, or locked into position by way of quick release lever 211. Releasing quick release lever 211 allows c-clamp 204 to be:
slid backwards and forwards in adjustment slot 208; and
rotated.

When the quick release lever 211 is positioned in a locking position, the c-clamp 204 is clamped onto the bicycle rack lower support 13 and is no longer adjustable.

In use, adjustability of c-clamp 204 facilitates the pannier frame 100 being adjustable in a fore and aft direction.

Pannier frame 100 composite body 201 also incorporates guard member 209.

Aspects of the present invention have been described by way of example only and it should be appreciated that modifications and additions may be made thereto without departing from the scope thereof as defined in the appended claims.

1. A pannier frame assembly, comprising:
at least one pannier frame member; and
at least one connector element on each side of a bicycle rack having a top deck, the at least one connector element configured to releasably hold the pannier frame member,
characterised in that the at least one connector element and/or pannier frame member is/are configured to allow the pannier frame member to be adjusted in a forward and/or backward direction with respect to the bicycle rack, in use, when mounted to a bike

2. The pannier frame assembly of claim 1 wherein the at least one connector element is in the form of clamp members on the sides of the bicycle rack top deck.

3. The pannier frame assembly of claim 2 wherein the clamp members are formed integrally with the top deck.

4. The pannier frame assembly of claim 2 wherein the clamp members are attached to the top deck by way of screws, hooks or clamps.

5. The pannier frame assembly of claim 2 which includes at least four clamp members attached to the top deck of the bicycle rack, two per side and located in substantially fore and aft positions on the top deck.

6. The pannier frame assembly of claim 2 wherein the clamp members comprise a bottom fixed jaw and a releasable top jaw.

7-15. (canceled)

16. A pannier frame comprising:
an upper frame member;
a lower frame member; and
a guard member,
wherein the lower frame member includes at least one lower frame member connection device; and
wherein the upper frame member is configured to be capable, in use, of engaging with at least one connector element of a bicycle rack in a manner which allows the pannier frame to be adjusted in a forward or backward direction with respect to the rack.

17. The pannier frame as claimed in claim 16 wherein the upper frame member comprises a tube which slidably engages with at least one connector element of a bicycle rack.

18. The pannier frame as claimed in claim 16 wherein the upper frame member includes a plurality of attachment portions which are configured to engage with at least one connector element of a bicycle rack.

19. The pannier frame as claimed in claim 16 wherein the upper frame member is configured to facilitate attachment of a standard hook type pannier bag attachment system.

20. The pannier frame as claimed in claim 16 wherein the pannier frame is constructed from a single piece of material.

21. The pannier frame assembly of claim 1 further including a lower frame member connection device.

22. The pannier frame assembly of claim 21 wherein the lower frame member connection device is a dual clamp wherein a first clamp of the dual clamp clamps onto a portion of a bicycle rack or bicycle frame and the second clamp of the dual clamp clamps onto the lower frame member.

23. The pannier frame assembly of claim 21 wherein the lower frame member connection device is a c-clamp.

24. The pannier frame assembly of claim 23 wherein the c-clamp is connected to the lower frame member by way of an adjustment slot.

25. The pannier frame assembly of claim 21 wherein the lower frame member connection device includes a quick release cam.

26. The pannier frame assembly of claim 1 wherein the pannier frame is configurable in at least a direction of forward or rearward adjustability with respect to the bicycle rack.

27. The pannier frame assembly of claim 1 wherein the pannier frame is configurable in a direction of upward or downward adjustability.

28. A kit of parts for the adaption of a non-pannier compatible bicycle rack to allow fitment of pannier bags thereto, the kit of parts comprising:
at least one connector element in the form of a strap;
at least one pannier frame member; and
at least one lower frame connection device in the form of a clamp.

29. A kit of parts as claimed in claim 28 including at least one spreader element.

30-37. (canceled)
